(19) United States
(12) Patent Application Publication
(10) Pub. No.: US 2026/0154511 A1
(43) Pub. Date: Jun. 4, 2026

(54) SCRIPT INSERTION

(71) Applicant: Roblox Corporation, San Mateo, CA (US)

(72) Inventors: Kartik AYYAR, San Mateo, CA (US); Brian YIN, San Mateo, CA (US); Ankur GUPTA, San Mateo, CA (US); Brent VINCENT, San Mateo, CA (US)

(73) Assignee: Roblox Corporation, San Mateo, CA (US)

(21) Appl. No.: 19/407,128

(22) Filed: Dec. 3, 2025

Related U.S. Application Data
(60) Provisional application No. 63/727,509, filed on Dec. 3, 2024.

(51) Int. Cl. G06F 40/40

(52) U.S. Cl. CPC G06F 40/40

(57) ABSTRACT

Various implementations relate to methods, computer-readable media, and to automatically insert a script in a virtual environment. In some implementations, a method includes receiving a natural language prompt from a user, the natural language prompt specifying one or more functional requirements for the script. The method further includes providing the natural language prompt, a default prompt, and context information to a large language model (LLM). The method further includes obtaining, as output of the LLM and in response to the providing, the script and an attachment location for the script, wherein the attachment location identifies a particular entity associated with the virtual environment. The method further includes inserting the script in the virtual environment at the attachment location, wherein the script is executable in the virtual environment after the inserting.

### CROSS-REFERENCE TO RELATED APPLICATIONS

This application claims priority under 35 U.S.C. § 119(e) to U.S. Provisional Patent Application No. 63/727,509, entitled “SCRIPT INSERTION,” filed on Dec. 3, 2024, the content of which is incorporated herein in its entirety.

### TECHNICAL FIELD

Various implementations described herein relate generally to script generation and insertion, and more particularly but not exclusively, to methods, systems, and computer-readable media to create and manage scripts in a virtual environment using a large language model (LLM).

### BACKGROUND

Script insertion permits developers to attach scripts to instances within a data model associated with a platform for building and publishing games and/or virtual experiences in a virtual environment. Scripts, for example, human-readable code that is executable within a virtual experience (which may be hosted by a virtual environment or a similar platform), can enable a developer (e.g., a game or virtual experience developer) to control object behavior within the corresponding virtual experience. For example, a tree object in a virtual experience may have an associated script that, upon execution, causes an avatar that is in contact with the tree object to temporarily become immobile for a period of time per criteria specified by the developer. Developers need to manually write scripts in a scripting language supported by the virtual environment to control object behavior.

General purpose large language models (LLMs) are capable of generating scripts. These general purpose LLMs suffer from problems such as inaccuracies (e.g., misinterpreting parameters specified by the developer, generating scripts referring to incorrect objects, generating scripts that do not correctly perform requested actions, etc.) and/or hallucinations (e.g., where the LLM hallucinates objects or other non-existent entities in the generated script, causing the generating script to fail and/or operate unsuccessfully). Current artificial intelligence (AI) tools for script generation and insertion are limited in capability and usefulness for script generation.

These techniques are also inadequate with regards to various aspects of successfully adapting script insertion to manage issues such as identifying correct script instances, adapting scripts to game/virtual experience contexts, attaching the script to an appropriate object within a game/virtual experience, and may have limited or no support for iterating on script generation based on user interaction to improve and/or modify scripts.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform or control performance of the actions.

According to one aspect, a computer-implemented method to automatically insert a script in a virtual environment is provided, the method comprising: receiving a natural language prompt from a user, the natural language prompt specifying one or more functional requirements for the script; providing the natural language prompt, a default prompt, and context information to a large language model (LLM); obtaining, as output of the LLM and in response to the providing, the script and an attachment location for the script, wherein the attachment location identifies a particular entity associated with the virtual environment; and inserting the script in the virtual environment at the attachment location, wherein the script is executable in the virtual environment after the inserting.

Various implementations of the computer-implemented method are described herein.

In some implementations, the default prompt includes a task instruction, at least one example prompt and a corresponding example script, one or more script insertion rules, or any combination thereof.

In some implementations, the method further comprises receiving a selection of a virtual object within the virtual environment from the user, and wherein providing the context information to the LLM comprises providing an identification of the virtual object.

In some implementations, the particular entity is the virtual object.

In some implementations, the context information is from the virtual environment and includes a data model hierarchy for the virtual environment that includes information about entities associated with the virtual environment including the particular entity.

In some implementations, the data model hierarchy for the virtual environment is represented as a JavaScript Object Notation (JSON) tree and the method further comprises, prior to providing the data model hierarchy to the LLM, transforming the data model hierarchy into a compact representation that includes a sub-tree comprising nodes associated with a selected portion of the data model hierarchy, nodes added or modified within a threshold time, and nodes associated with a global container, wherein the global container is a data structure that includes data regarding the entities associated with the virtual environment.

In some implementations, the context information includes one or more previous prompts from the user, one or more previous outputs of the LLM, or a combination thereof.

In some implementations, the particular entity includes a global container associated with the virtual environment, wherein the global container is a data structure that includes data regarding entities associated with the virtual environment.

In some implementations, the method further comprises instructing the LLM to act as a planner based on the natural language prompt and a selection context, wherein the LLM generates a plan comprising sequential operations to create the script, executes the sequential operations in the plan to create the script, and attaches the script.

In some implementations, the method further comprises, after the LLM generates the plan, providing the plan to a user; obtaining user feedback, user modifications, or a combination thereof with respect to the plan; and before executing the sequential operations in the plan, updating the plan based on the user feedback, the user modifications, or the combination thereof.

In some implementations, the method further comprises executing the script; after executing the script, displaying to the user results of the execution of the script; receiving one or more script modification prompts from the user; providing the script modification prompts to the LLM; and obtaining, from the LLM, an updated script, an updated attachment location, or a combination thereof.

In some implementations, the obtaining comprises obtaining the script prior to obtaining the attachment location or obtaining the attachment location prior to obtaining the script.

According to another aspect, a non-transitory computer-readable medium is provided. The non-transitory computer-readable medium has instructions stored thereon that, responsive to execution by a processing device, causes the processing device to perform or control performance of operations comprising: receiving a natural language prompt from a user, the natural language prompt specifying one or more functional requirements for a script; providing the natural language prompt, a default prompt, and context information to a large language model (LLM); obtaining, as output of the LLM and in response to the providing, the script and an attachment location for the script, wherein the attachment location identifies a particular entity associated with a virtual environment; and inserting the script in the virtual environment at the attachment location, wherein the script is executable in the virtual environment after the inserting.

Various implementations of the non-transitory computer-readable medium are described herein.

In some implementations, the context information is from the virtual environment and includes a data model hierarchy for the virtual environment that includes information about entities associated with the virtual environment including the particular entity.

In some implementations, the context information includes one or more previous prompts from the user, one or more previous outputs of the LLM, or a combination thereof.

In some implementations, wherein the operations further comprise instructing the LLM to act as a planner based on the natural language prompt and a selection context, wherein the LLM generates a plan comprising sequential operations to create the script, executes the sequential operations in the plan to create the script, and attaches the script.

According to another aspect, a system is provided, the system comprising: a memory with instructions stored thereon; and a processing device, coupled to the memory, the processing device configured to access the memory and execute the instructions, wherein the instructions cause the processing device to perform or control performance of operations comprising: receiving a natural language prompt from a user, the natural language prompt specifying one or more functional requirements for a script; providing the natural language prompt, a default prompt, and context information to a large language model (LLM); obtaining, as output of the LLM and in response to the providing, the script and an attachment location for the script, wherein the attachment location identifies a particular entity associated with a virtual environment; and inserting the script in the virtual environment at the attachment location, wherein the script is executable in the virtual environment after the inserting.

Various implementations of the system are described herein.

In some implementations, the context information is from the virtual environment and includes a data model hierarchy for the virtual environment that includes information about entities associated with the virtual environment including the particular entity.

In some implementations, the context information includes one or more previous prompts from the user, one or more previous outputs of the LLM, or a combination thereof.

In some implementations, wherein the operations further comprise instructing the LLM to act as a planner based on the natural language prompt and a selection context, wherein the LLM generates a plan comprising sequential operations to create the script, executes the sequential operations in the plan to create the script, and attaches the script.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram of an example system architecture that uses a large language model (LLM) to perform script generation and insertion, in accordance with some implementations.

FIG. 2 is a flowchart of an example method to use a large language model (LLM) to generate and insert a script, in accordance with some implementations.

FIG. 3 is a diagram illustrating portions of a default prompt, in accordance with some implementations.

FIG. 4 is a diagram illustrating aspects of a data model hierarchy used when generating scripts, in accordance with some implementations.

FIG. 5 is a flowchart of an example method to use an LLM as a planner for script generation, in accordance with some implementations.

FIG. 6 is a flowchart of an example method to use an LLM as a planner for script generation, in accordance with some implementations.

FIG. 7 is a flowchart of an example method to interactively update a script, in accordance with some implementations.

FIG. 8 is a diagram illustrating an example of prompt engineering flow, in accordance with some implementations.

FIG. 9 is a diagram illustrating an example LLM chaining flow, in accordance with some implementations.

FIG. 10 is a diagram illustrating an example chaining flow, in accordance with some implementations.

FIG. 11 is a diagram illustrating iterative prompt updation, in accordance with some implementations.

FIG. 12 is a diagram illustrating prompt-driven script editing, in accordance with some implementations.

FIG. 13 is a diagram illustrating script editing using artificial intelligence (AI), in accordance with some implementations.

FIG. 14 is a block diagram that illustrates an example computing device which may be used to implement one or more features described herein, in accordance with some implementations.

### DETAILED DESCRIPTION

Various implementations described herein are directed towards, inter alia, providing tools (including custom large language models (LLMs), model tuning, automatic prompt generation techniques, etc.) to perform script generation and insertion using a data model in a virtual environment platform for building and publishing games and/or virtual experiences.

For example, various implementations relate to attaching a script (e.g., to an object within a game or virtual experience). Various implementations relate to incorporating data model awareness in script generation that provide the ability to represent a data model more effectively, thereby providing improved usage of computing resources during script generation and/or insertion. Various implementations provide iterative script editing functionality that permits improved plan creation for a large language model (LLM) and/or iterative fixes to errors in generated scripts.

A problem addressed herein is the difficult task of successfully performing script generation and insertion using a large language model (LLM) for scripts that are executable within a virtual environment. Script generation using LLMs has several problems. Two problems are script quality and poor attachment ability. With respect to script quality, an LLM may generate a script that cannot run at all or the generated script, when executed, does not achieve a correct or user-specified outcome. Traditional LLM generation of scripts does not utilize data model context of a virtual environment within which the script is to be executed. Poor attachment ability refers to the problem of script insertion that offers limited attachment options (where attachment refers to the script being inserted in the virtual environment with reference to one or more entities associated with the virtual environment).

In one or more implementations, resource-efficient techniques that are capable of generating and inserting scripts are described that can effectively manage the context of a virtual experience on a virtual environment platform and that are more effective at achieving user-defined outcomes for script execution. By providing relevant context to the LLM used to generate scripts, such as a more fully defined data model hierarchy, script generation and insertion quality is enhanced. A script may be generated with respect to such a data model hierarchy. These techniques provide for handling a diverse set of script generation prompts with more accurate script attachment locations. Various implementations also provide for generation of context-aware scripts with respect to attachment locations.

Various implementations described herein can improve code quality (of the code in the generated script(s)), including ability to achieve user-specified objectives and context-awareness for scripts that are executable within a virtual environment. The techniques may also improve insertion success, e.g., attaching the script at an appropriate attachment location, such as in association with a particular object or another entity in a virtual experience hosted in the virtual environment.

Various implementations also provide for improved user interaction with a code editor for the script, which is helpful for modifying an automatically generated script manually to resolve issues or problems in the generated script. The improved user interaction may also make it easier for a user to provide commands to the LLM for automated script refinement. Iterative, LLM-driven script generation in this manner is computationally efficient, as repeated manual user tweaking and testing of scripts is replaced by automated script generation.

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be affected in connection with other implementations whether or not explicitly described.

In various implementations, a method includes receiving natural language user prompts used to generate scripts. The method further includes generating corresponding scripts that functional and are deployable within a virtual environment. The virtual environment may provide various virtual experiences. For example, a virtual experience can be a game or another experience where various platform users can join and participate in gameplay. A virtual experience can also refer to a game development studio or another developer user interface, where developer users can simulate the game while building it, execute and test scripts, etc., but the virtual experience is not joinable by player users while under development. In various implementations, Chain-of-Thought (CoT) analysis is used for script generation. For example, CoT analysis may include prompt engineering that generates prompts for an LLM that command the LLM to perform CoT reasoning.

In various implementations, CoT reasoning may include breaking down script generation into a plurality of stages and when generating the script, providing reasoning behind the individual stages of script generation. Given the context for the generated script, optional relevant Application Programming Interface (API) information (such as API documentation), and a designed attachment location as part of the prompt, an LLM may generate a script accordingly. Alternatively, the script generation may include automatic prompt-engineering (APE) based on a framework for optimizing a prompt to cause the LLM to generate a corresponding script with one or more properties as specified in the framework.

In various implementations, a data model is managed and/or transformed in various advantageous ways. For example, a data model for a client may originally be represented using a JavaScript Object Notation (JSON) tree format having a variety of properties. Such a client tree may be the basis of a sub-tree. Such a sub-tree may be further processed at a backend to represent context information in a manner that facilitates the script generation. Using such a sub-tree and performing such processing may permit management and/or representation of important aspects of a data model and may provide context while reducing use of computing resources (such as memory and/or storage) more effectively through more efficient data formats and limiting the data that is included in the context information that is utilized during script generation.

In various implementations, a large language model (LLM) is used to attach a script in a virtual experience of a virtual environment. For example, the virtual experience may be a game, but virtual experiences are not limited to games. Such script insertion involves providing one or more prompts as input to the LLM. For example, the one or more prompts may include a task instruction prompt, a few-shots prompt, an input fields and input context prompt, or any combination thereof. In various implementations, a task instruction prompt may be a natural language prompt which describes various aspects (e.g., functional requirements) of the script the LLM is to generate.

Few-shot prompting is a technique that provides an LLM with a small number of examples (e.g., 5 examples, 10 examples, etc.) to illustrate to the LLM the target task, format, or style (e.g., including representative inputs and corresponding outputs) before the LLM performs generation, e.g., of a script. By including few-shot examples within the prompt itself, the prompt can direct the LLM towards script generation that matches the user's requirements without the LLM being trained on a training dataset with many examples. Few-shot prompting can also enable generation by the LLM of output of a kind that is not included in the training dataset, but that is of a same category as example outputs provided in the small number of examples.

An input field is the primary text entry area where a user types a query or instructions to the LLM. In various implementations, the prompts may be provided individually. In various implementations, two or more of the prompts may be provided to the LLM as part of a single combined prompt. In response to such prompts, the LLM generates a block of code as an example output script. An input context prompt refers to the practice of providing the LLM with comprehensive background information, situational details, and specific instructions within the prompt itself to ensure the LLM can successfully represent the user's objectives.

In a first case, script insertion is performed when a goal is to add custom logic onto a base part instance in the data model, or more generally, an asset retrieved from an online store. In a second case, a user may want to provide a script not associated with a particular instance but instead provide a script associated with an entire virtual environment (e.g., associated with a global container for the entire virtual environment).

For the first case, prior techniques face issues with lack of awareness of a data model hierarchy when generating a script for an asset. For the second case, prior techniques may not take actions to attach scripts directly to global containers.

In various implementations, script insertion using an LLM may include Chain-of-Thought (CoT) prompting. For example, few-shot CoT or zero-shot CoT may be used. In few-shot CoT, crafted input is provided to the LLM which is mapped to reasoning, and then in turn, mapped to output pairs. In zero-shot CoT, the prompt to the LLM may include a command to use thought trigger words/phrases to directly provide reasoning in the response.

For example, the prompt may include “think step-by-step and explain your work” as part of the prompt. This zero-shot approach causes the LLM to perform step-by-step reasoning (“think step-by-step”) based on the various inputs in the prompt and provide a crafted reasoning structure as part of the LLM output (“explain your work”). By forcing the LLM to perform multi-step reasoning, such CoT prompting causes the LLM to execute in a step-by-step manner rather than generate the entire output in one step, which can reduce errors in tasks such as mathematical reasoning.

As an example of Chain-of-Thought (CoT) prompting, there may be a series of successive steps taken to differentiate the function ƒ(x)=\sqrt{x²+3x+2}. Rather than simply requesting the derivative of this function, in response to CoT prompting, an LLM executes in a manner that applies one principle at a time to avoid errors.

For example, as a first step, to differentiate the function ƒ(x), first set y=(x²+3x+2)^{1/2}.

Then, the derivative is computed using the chain rule:

$$\frac{dy}{dx} = \frac{1}{2} {( {x}^{2} + 3 x + 2 )}^{- 1 / 2} \cdot \frac{d}{dx} .$$

Then, the inner function (x²+3x+2) is differentiated to yield the derivative 2x+3. This resulting derivative is substituted back into the original derivative such that

$$\frac{dy}{dx} = \frac{1}{2 \sqrt{{x}^{2} + 3 x + 2}} .$$

(2x+3). Thus, the derivative of ƒ(x) is

$$\frac{2 x + 3}{2 \sqrt{{x}^{2} + 3 x + 2}} .$$

This stepwise approach can help reduce the chances that various implementations make a mistake in the mathematical reasoning, because each step is based on a specific reason, such as a theorem, axiom, or definition.

CoT approaches can cause the LLM to perform internal reasoning tasks, because responding to the prompt involves generating a response that includes material responsive to multiple individual reasoning stages as requested in the prompt. This approach may provide an unrestricted format for script generation. CoT approaches help preserve generated script accuracy.

In various implementations, enhanced data model awareness capabilities are provided. These additional capabilities address limitations of prior approaches such as an inability to send a data model to a backend. Such limitations may occur due to network latency and bandwidth constraints and large data model representation size. To provide an LLM-friendly context format, it may be helpful to provide a compact representation of a data model, such as a textual representation. For example, a compact representation uses fewer input tokens than other representations. Since LLM execution computational resource use increases as the number of input tokens, using the compact representation causes the LLM execution to be performed with fewer computational resources being used.

Further, prior approaches may have a limit on a size of a context window (e.g., total number of tokens taken into account by the LLM when generating a response to the prompt). Since execution time and cost increase as context length increases, a compact representation of context information can save computational costs and reduce time to inference (when obtaining a generated script from an LLM).

In various implementations, the data model may be represented in a JavaScript Object Notation (JSON) tree format, e.g., at a client device. The nodes of such a tree are instances of the data model, which are individual objects that make up the entire game world, which may include parts, scripts, sounds, players, etc. These instances may have several properties, including an identifier of the instance, a name of the instance, a class name of the instance, whether the instance is selected, whether the instance is recently added/updated in the current conversation session, source code of a generated script(s) (optional) associated with the instance, and a list of sub-hierarchy instances, etc.

Instead of sending an entire data model from a client device to a server, in various implementations, a data model sub-tree may be sent that includes the following three portions: a selected hierarchy of the data model sub-tree, recently added/modified portions of the data model sub-tree, and global containers of the data model sub-tree. The sub-hierarchy of each selected/recent instance may be selectively sent based on a client-side flag that indicates how many levels of depth of the hierarchy under each selected instance of the data model are to be sent over to the server. The sub-tree may be a compact representation of the original JSON tree that adequately captures context information while being smaller in data size.

For example, a user may select one or more instances used to interact with a scripting assistant. The context to collect may be based on information including currently selected instances, recently selected/interacted instances (in which case, instances from the last K conversations between the user and the script generation/insertion LLM may be cached), and commonly used context information (for example, context information with a usage metric that exceeds a threshold), and information which may correspond to one or more global containers.

The global containers may include, as examples, a service that permits users to set default values for properties in a player object, a container service for a script, a module script, and/or other scripting-related assets that are meant for server use, a general container service for objects that are available to both the server and connected game clients, etc.

For example, with respect to information from a selected hierarchy, the corresponding instances may include selected instances having a hierarchy, such as instances along the data model tree path. With respect to recently added/modified, the corresponding instances may be instantiated or updated in a number of recent K conversation rounds. With respect to global containers, the corresponding instances may be higher-level instances (mostly scripts) in a few chosen global containers (examples of which are presented above).

The data model management capabilities may be implemented by deserialization, transformations, and token reduction and formatting operations (converting the information such as a JSON tree or JSON object into an LLM-friendly text string). Deserialization involves a process of converting a data structure or object from a stored format into a usable object in memory. For example, the deserialization may include converting an original JSON tree received from the client into a data model data structure (e.g., serialized data structure) and may include performing one or more schema validations.

Server-side transformations may involve performing filtering and property updates on the data model. The token reduction and formatting may involve conversion of the tree into an LLM-friendly string (e.g., a sequence of tokens). For example, the token reduction and formatting may include a JavaScript Object Notation (JSON) representation or an Extensible Markup Language (XML) representation. When using XML, the data model representation may be compacted by using instance grouping and/or level trimming techniques. These techniques involve organizing the XML data more effectively and removing unnecessary information to reduce the size of the XML representation. These techniques are discussed below in greater detail.

With respect to transformations, the transformations may occur recursively. The filtering may include various aspects of pruning the data model tree. For example, filtering may include filtering out instances (and corresponding sub-hierarchies) that match one or more criteria. At the client-side, such filtering may involve general data model extraction heuristics. At the backend, (e.g., the backend may be server-side) more fine-grained filtering logic may be implemented.

For example, one or more containers may not be present in the filtering, such as a container that manages in-experience text chat services for the virtual environment. Another backend technique may be to discard deeply nested instances.

When performing property updates, the property updates may involve capitalizing (converting to ALLCAPS) or camelizing (converting to CamelCase) instance names. For example, capitalizing involves making the first letter a capital, while camelizing places the instance name in camel case, which means writing phrases without spaces and punctuation and with capitalized words. Another aspect of property updates may be reducing instance id lengths. For example, “Instance_xxx_xxx” is modified to “123” where “xxx” stands for such original identifying numerals.

In the token reduction and formatting process, the data model may be represented using JSON or XML. A JSON representation may directly transform deserialized data model data structure into a JSON dictionary (without additional token optimizations).

An XML representation may permit additional token optimization rules, such as grouping similar instances and level trimming. This may result in token reduction, e.g., a 35-40% reduction (depending on the specific XML characteristics). In instance grouping, if there are multiple similar instances in the data model, the XML representation may represent these instances as a group rather than storing redundant information.

Another aspect of compression and formatting may include level trimming. Such level trimming may involve ignoring deeply nested children in the data model tree. While JSON and XML are provided as examples of markup languages used to represent the data model data structure, other markup languages such as YAML Ain′t Markup Language (YAML) may be used in various implementations.

In various implementations, there may be an LLM chaining flow. For example, in one flow, there may be a prompt and a selection context. The prompt and selection context may be provided as a data model query to the LLM, causing the LLM to generate an object model defining infrastructure information for the virtual environment having parts (and potentially subparts) and an associated script.

The object model may be provided to a planner (e.g., a query planner) along with the prompt and selection context. The planner generates information about where to attach the script and a plan for generating the script. This information (e.g., the prompt and the selection context, the object model, and the output of the planner) is provided as a script generation prompt and is used to generate a final script output for use in the virtual environment.

There may also be another flow provided and implemented. For example, there may be a user prompt, a data model context, few-shots information, and rules. This information is provided with an injected context as a planning prompt and also used as a script generation prompt. The planning prompt generates structured output, the structured output including reasoning, a script plan, and an attachment location.

The few-shots information may include additional information provided in a few-shots format to help guide the LLM, wherein the few-shots information is applied when using a user prompt and corresponding data model context as an input to yield as output of the LLM a script plan and an attachment location as output. The script generation prompt is also provided to the LLM together with the structured output from the planning prompt (e.g., reasoning, script plan, and attachment location). Using this information, the script generation prompt causes the LLM to generate the corresponding script.

When generating the planning prompt, one or more few-shots examples may be used. In various implementations, the few-shots example may include a manually created CoT. The CoT may help interpret a user request, check data model context relevance, and analyze an attachment location with reasoning operations. For example, there may be an initial natural language user prompt. Based on the initial natural language prompt, markup in the data model context may be identified. The identified markup may establish a conceptual framework that governs what is meant by the initial natural language prompt in order to create a generated script that better suits a specified purpose of the user.

Another aspect of a planning prompt may relate to rules and constraints. These may refer to rules and constraints specified using natural language to direct the output of the LLM. For example, the rules may help disambiguate words potentially unclear words such as “this” or “it,” place restrictions on how scripts are attached, help define rules for attaching information related to player state, provide ways to handle scripts attaching to particular types of instances, make assumptions about which parts exist, specify particular scripting for performing specific tasks, etc.

In various implementations, a planning prompt may have a specific prompt tuning flow. The flow may include receiving a prompt, provided for evaluation. The evaluation may take input, context information, and assertions associated with scripting in the virtual environment. The context information may include information such as script insertion rules, data model context, conversation context, and manual prompt optimization information.

The evaluation may provide a set of failed cases. From the failed cases, failure patterns may be extracted, and the prompt updated. This iterative approach provides for a prompt tuning flow in which successive prompts address issues (e.g., failed cases) generated by evaluating a previous prompt, preferably providing for progress with these cases and leading to improved results as the prompts are iteratively refined.

These aspects of data model awareness enable LLM-based script generation to have certain advantageous properties. For example, the LLM may have the ability to handle a more diverse range of scripting scenarios. There may also be an improved capability to permit different scripting behavior (relating to attributes of generated scripts) by the LLM for different kinds of prompts.

Various implementations may also provide capabilities for user interface (UI) scripting. For example, the various implementations may facilitate automatically constructing scripts that specify aspects of how a virtual environment is to interact with a user. Various implementations may also provide an ability to attach scripts to instances even if not explicitly selected. Various implementations may also make it possible to provide a reusable data model awareness component to other AI building tools (e.g., a coding program that provides a development environment may benefit from integrating these techniques into the development environment).

In various implementations, there may be a dependency between script type and script content. Reducing the number of LLM calls in such cases can reduce Chain-of-Failures errors that may occur where mistakes in earlier LLM runs cause a whole LLM chain to break. This feature of managing dependencies may reduce sensitivity to errors across a chain. These techniques may also introduce human feedback, providing for script iteration and editing.

Iterative editing techniques may provide additional improvements when generating scripts beyond the techniques discussed above. For example, there may be techniques to provide a resolution for one or more Chain-of-Failures errors. For example, there may be a single LLM call. To better manage Chain-of-Failures errors, the order of script generation and script location/type predication may be reversed. For example, in various implementations, script content is generated first. Then, script content is used to guide script type/location prediction. This order is reversed in other implementations.

Various implementations may also use an iterative editing context. Such an iterative editing context may take into account previous conversation context between the user and the LLM (e.g., prior prompts provided to the LLM and corresponding responses, e.g., scripts and/or attachment locations generated by the LLM) as editing iterations occur. The context may also include context information from other scripts. Such context may be located K levels below the selected or relevant instances in the tree (depending on a particular configuration, such as available memory). Such scripts may have been previously created by the script insertion tool (LLM) during past interactions with the user.

When performing the iterative editing process, a particular prompt structure may be utilized. For example, there may be a specific plan creation technique. Here, the LLM is tasked with (based on the provision of an appropriate prompt) explicitly decomposing the request into individual steps, forming a clear plan of action. For example, such action generation may include script insertion, script editing, script deletion, and/or remote event creation. Various implementations may use specific prompt templates that are used for generating specific types of actions.

For example, there may be a prompt provided to the LLM that instructs the LLM to perform a CoT plan decomposition when performing a given script generation task. Such a prompt may give guidance to the LLM about how to break a plan for an overall task into individual pieces and/or operations. The prompt may also instruct that the LLM consider context and/or user objective, particular lines of script to change when performing the updating, how to successfully attach a new script, and the relevant engine API calls/methods to use in order to achieve a stated user objective.

Interactive editing may also include progressive refinement of a script based on user input and/or interaction. For example, the user may request a script for a particular purpose. The user may then indicate that the script does not work and request that the indicated non-working script (e.g., non-working portions) be fixed. The interactive editing process may then respond to the user with an apology for the mistake (which may identify the problem), develop a plan to fix the problem, and then output an edited script. The updating may include deleting and/or regenerating the script or editing an existing script.

Various implementations may enable the use of a recent instance of results generated by the LLM as context in the prompt to enable a scripting assistant based on the LLM to refer to old scripts/assets in a conversation. In various implementations, the relevant conversational flow is captured and incorporated into a past edited/inserted script. Capturing and incorporating conversational flow into a past edited/inserted script may help reduce hallucinations (e.g., the generated script referring to non-existing entities in the virtual environment) and outputs that do not adequately account for the context.

There may also be an output window that adds generated information from the output window as part of the LLM context. This may incorporate output window display information including script printing statements and error logs. The inclusion of error logs may provide information that is usable by the LLM to identify issues and establish aspects of the script that may be edited. For example, the output logs may include a script instance that causes the error, an error message, and a line number that triggered the error. Using this information provides an interactive way to fix script generation/insertion issues.

For example, it may be determined that a generated script does not work as specified by the user. Modification instructions may be received from the user, and the generated script may be regenerated and/or updated based on the modification instructions.

The technical solutions discussed herein may have a variety of applications. For example, the implementations described herein may be used in a customized fine-tuned LLM to provide script generation and insertion results that work well in a virtual environment corresponding to the fine-tuned LLM. The techniques may also improve script quality.

For example, this quality benefit may involve handling complex use cases. For example, these use cases may include creating module scripts for a custom vector class, multi-script insertion on three selected parts that adjust walking speed when touch, a script for creating/interacting with user interface (UI) elements (and avoiding hallucinations), etc.

The techniques may also provide a script iteration and debugging flow. Various implementations include capabilities to iteratively refine an existing script, or provide an inserted script based on user feedback or automated script evaluation without rerunning the entire script insertion. This capability is also relevant for debugging purposes when a user benefits from assistance to fix specified scripting bugs based on debugging messages, such as from an output window.

The techniques may also improve a client user interface experience. Various implementations can support generation of multiple responses that contain different attachment locations and scripts in response to a prompt. To aid in this capability, the techniques may provide a client-side conversation widget (or another UI element) may support such a flow that coordinates the use of different attachment locations and scripts.

Various technical solutions discussed herein provide improved ways of using a large language model (LLM) to generate and insert a script in a virtual environment, where the script can perform one or more actions in the virtual environment, such as modifying object status, causing objects to move, etc. or perform any operation with respect to any entity in the virtual environment. The technical solutions include aspects related to attaching scripts (such as to particular objects or other entities within a virtual environment), data model awareness, and iterative editing. The technical solutions discussed herein provide improved ways to generate and insert scripts.

For example, script insertion by an LLM may be based on supplied information (e.g., as part of a prompt) to identify an attachment location. For example, an attachment location may be a global container or an identifier of a specific instance included in the data model context. Based on a natural language prompt to the LLM, an attachment location, and script type (and possibly script name and/or context information), the LLM can generate a script and attach the script appropriately to a global container or an instance.

With respect to attaching scripts, a task instruction and formats for a few-shots or zero-shot approach may be used, optionally with input fields and input context. This can generate example scripts as outputs. These scripts may achieve better results by using Chain-of-Thought (CoT) prompting.

With respect to data model awareness, various implementations enable the use of a subset of a data model context because only a small portion of a data model may be relevant to a user request. For example, portions of a data model such as a selected hierarchy, recently added/modified nodes, and global containers may be included in the subset. At a backend, deserialization, transformations and token reduction and formatting permit representation of the data model in a more memory-efficient manner. The data model awareness may permit use of a planning mechanism that better integrates context and constraints into the script generation. The data model awareness may also permit prompt tuning and permit a more diverse range of scripting scenarios.

With respect to iterative editing, the described techniques provide ways to resolve Chain-of-Failures issues more effectively. The techniques can also support iterative script editing based on context, such as previous conversations and relevant scripts. Iterative editing may decompose a user request into individual steps to form a clear plan of action. Iterative editing may also identify situations where a script is to be fixed (e.g., the generated script works improperly) and permit a user to interact with the LLM to make these corrections.

The technical solution provided herein thus provides improved automatic script generation and insertion using an LLM by using improved techniques to represent a data model and use the data model to provide context to the LLM in a prompt to generate a script. The technical solution also provides more effective ways to attach scripts properly (such as by generating attachment locations) and to break down user instructions into individual operations, such as by using Chain-of-Thought (CoT) techniques.

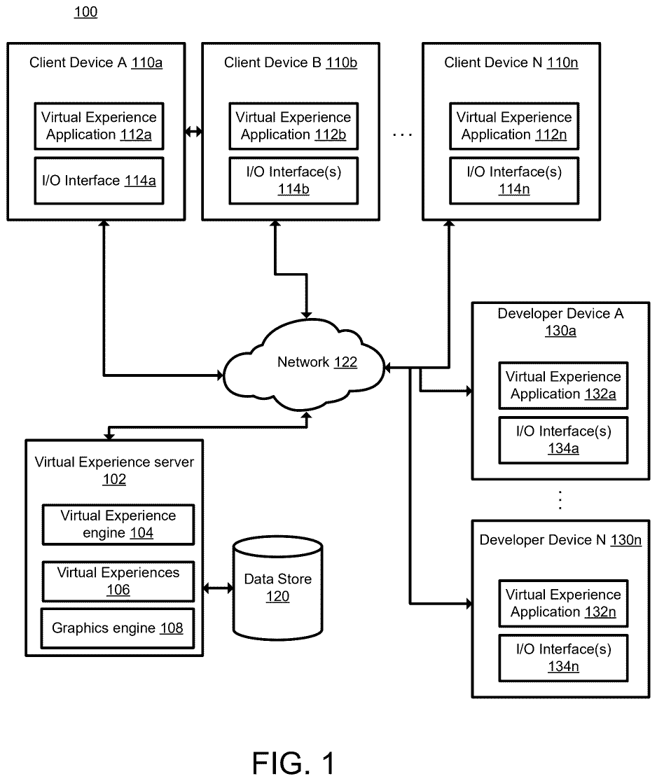

FIG. 1 is a diagram of an example system architecture that uses a large language model (LLM) to perform script generation and insertion, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

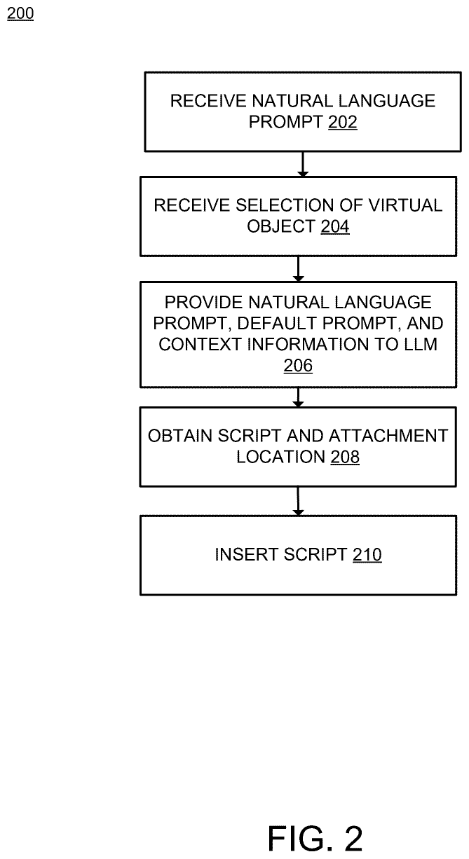

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 and/or virtual experience engine 104 and/or some other component(s) in FIG. 1 may perform one or more of the operations described below in connection with the flowcharts shown in FIGS. 2 and 5-7 and/or other operations described herein. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata (e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.).

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication), or other form of communication. A record of some or all user communications may be stored in data store 120 or within virtual experiences 106. The data store 120 may be utilized to store chat transcripts (text, audio, images, etc.) exchanged between participants, with appropriate permissions from the players and in compliance with applicable regulations.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. Other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online virtual experience server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experiences 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine/application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc. is provided as illustration. In some implementations, any number of client devices 110 may be used.

One or more characters (also referred to as an “avatar” or “model” herein) may be associated with a user where the user may control the character to facilitate a user's interaction with the virtual experiences 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that in some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using an I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character (e.g., avatar) can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, and upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, and upload content to the online virtual experience server 102 as well as interact with online virtual experience server 102 (e.g., provide and/or engage in virtual experiences 106 hosted by online virtual experience server 102). As such, the virtual experience application may be provided to the developer device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application 112. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

Developer device(s) 130 may implement script generation as presented herein locally (in virtual experience application 132) together with virtual experience server 102. For example, virtual experience engine 104 can perform script generation and insertion, or script insertion can be performed entirely at the virtual experience server 102. A large language model (LLM) may be incorporated into virtual experience server 102 and/or developer device(s) 130. The various implementations provided herein to automatically insert a script in a virtual environment may be implemented by virtual experience server 102, client device(s) 110, and/or developer device(s) 130, and any combination thereof.

FIG. 2 is a flowchart of an example method 200 to use a large language model (LLM) to generate and insert a script, in accordance with some implementations. The script may be inserted in a virtual environment. For example, such a virtual environment may include a virtual 3D space with one or more virtual objects contained therein.

The virtual environment may also store a respective data model associated with the one or more virtual objects, as well as information about the virtual 3D space. For example, the information may include locations of objects, physics properties and rules of the virtual 3D space, etc. These features may provide the virtual environment as described herein with additional features beyond those of an alternative integrated development environment (IDE) used for software development that are specific to 3D spaces. Method 200 may begin at block 202.

At block 202, a natural language prompt is received. For example, the natural language prompt may be received from a user, e.g., a virtual experience developer using a developer device 130. The natural language prompt may specify one or more functional requirements for the script to be generated. Block 202 may be followed by block 204.

At block 204, a selection of a virtual object is received. The selection of the virtual object may correspond to a selection of a virtual object within the virtual environment from the user. An identification of the virtual object may be a part of context information provided to the LLM. Such a selection may identify or help identify an attachment location for the script to be generated. However, block 204 is an optional operation, and various implementations may enable generating the script and determining a location for the script without selecting a virtual object. Block 204 may be followed by block 206.

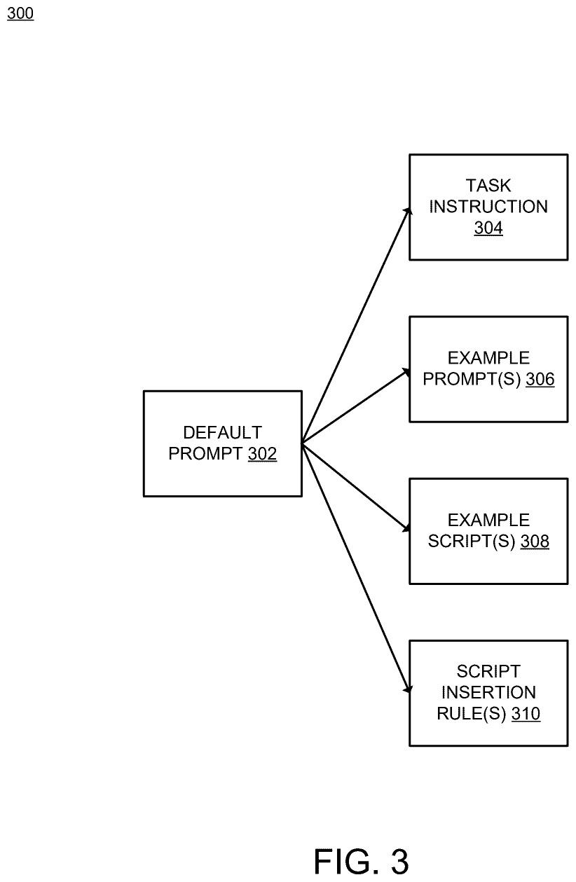

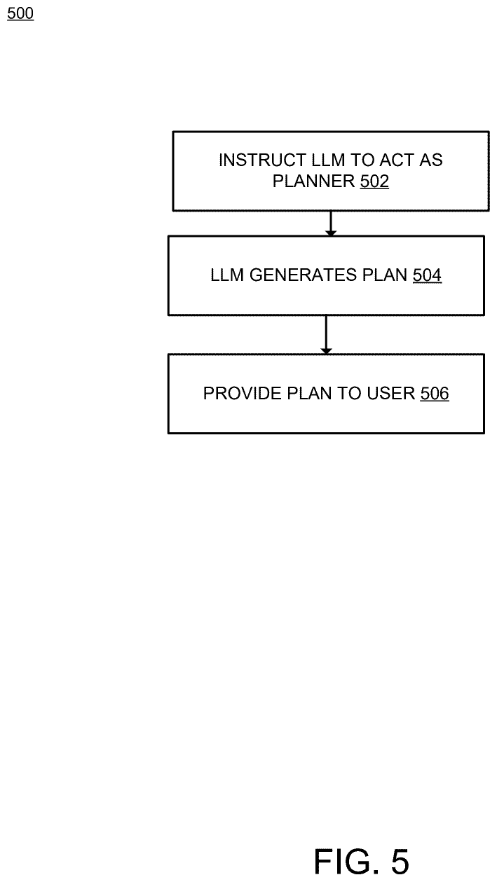

At block 206, the natural language prompt, a default prompt, and context information are provided to a large language model (LLM). Additional aspects of the default prompt are discussed in FIG. 3. Additional aspects of the context information are discussed in FIG. 5. Block 206 may be followed by block 208.

At block 208, the script and the attachment location are obtained. The script and the attachment location are provided as an output of the LLM and are responsive to providing the input to the LLM (the natural language prompt, the default prompt, and the context information). Here, the attachment location may identify a particular entity associated with the virtual environment.

Such a particular entity may be a virtual object. For example, such a virtual object may correspond to a tree that, when touched by an avatar in the virtual environment, kills the avatar. Other examples of the particular entity may be a specific avatar, a user interface (UI) frame, or another object in the virtual 3D space associated with the virtual environment. If block 204 is part of method 200, and a virtual object is selected, the virtual object may be designated as the attachment location. However, other techniques may use the input to the LLM to infer the attachment location in addition to generating the script itself. Block 208 may be followed by block 210.

At block 210, the script is inserted. For example, the script may be inserted into the virtual environment at the determined attachment location. Further, the script may be executable in the virtual environment after the inserting.

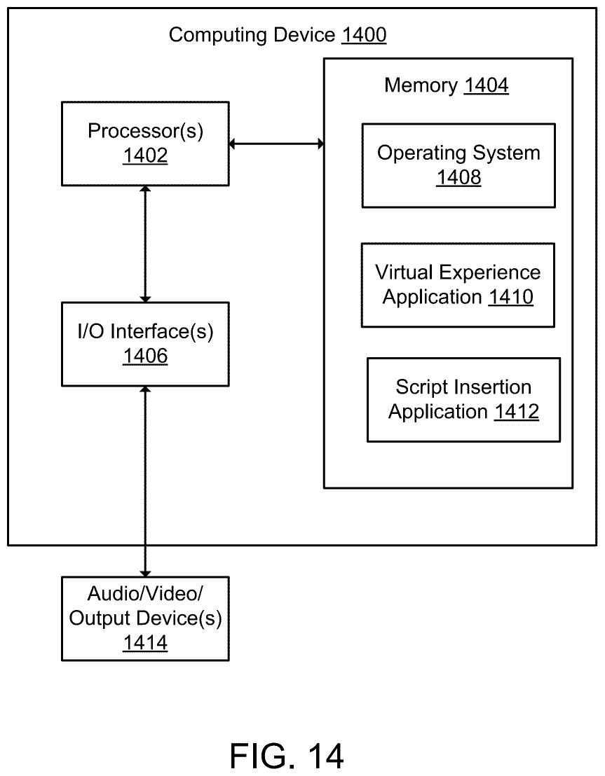

While FIG. 2 illustrates several operations provided in a certain order for carrying out method 200, it may be noted that there may be a variety of modifications to method 200 and/or other methods described herein. For example, other operations may be added, operations may be omitted, operations may be modified, operations may be combined, operations may be replaced by other operations, operations may be supplemented with other operations, or the order of operations may be varied. For example, the sequence of certain operations may be changed, or one or more of the operations may be carried out in parallel, as appropriate. Various operations as illustrated in method 200 and/or any other method described herein may be implemented by various hardware and/or software. For example, FIG. 1 and FIG. 14 illustrate various components that may implement the various operations provided in method 200, such as by being programmed using various appropriate software to configure the hardware to carry out method 200 and/or any other method described herein.

FIG. 3 is a diagram 300 illustrating portions of a default prompt, in accordance with some implementations. For example, there may be a default prompt 302. The default prompt 302 may include a task instruction 304. The default prompt 302 may also include example prompt(s) 306 and corresponding example script(s) 308 and example script insertion rule(s) 310. The default prompt 302 may include various information that provide a general-purpose LLM with background, context, and other information that help the LLM provide better results for specialized script generation and placement tasks. In various implementations, the default prompt 302 may omit one or more of 304-310.

For example, task instruction 304 includes instructions for the LLM that may help prepare the LLM to generate an appropriate script. For example, task instruction 304 may be “You are a scripting assistant that generates a script for a user making a game. In response to a prompt from the user, you will be asked to produce a self-contained game script (properly formatted for a JSON string entry) that can be directly inserted into the user's game. If no script is appropriate for the user's prompt, simply respond with an empty script and script_id.” As illustrated in this example, including a task instruction 304 provides the LLM with a framework as to how to approach the script generation problem, which improves the ability of the LLM to generate and place the script.

Example prompt(s) 306 may include samples of prompts that a user might provide. The corresponding example script(s) 308 and example script insertion rule(s) 310 are intended to include results of passing the example prompt(s) 306 through the LLM. Each example prompt 306 may be associated with multiple example script(s) 308 and example insertion rules 310. These examples provide samples that the LLM can mimic when generating scripts in actual use cases.

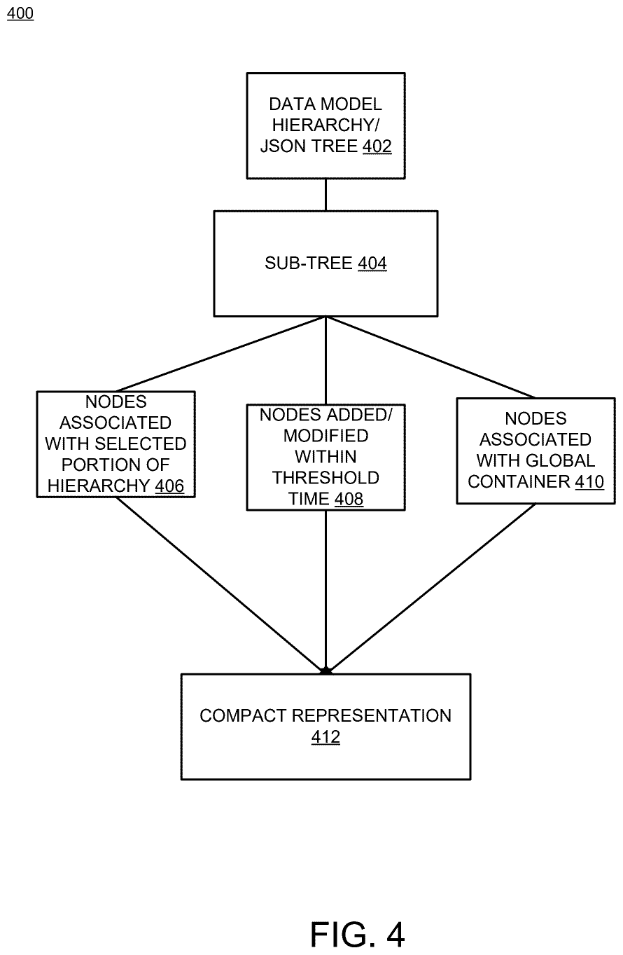

FIG. 4 is a diagram 400 illustrating aspects of a data model hierarchy used when generating scripts, in accordance with some implementations. The data model hierarchy 402 may be a tree-like structure that organizes every object in a game or another virtual experience, with a data model object as a root of the tree. All other objects, such as parts, terrain, lighting, and scripts are descendants in the data model hierarchy 402. The arrangement of objects in the data model hierarchy 402 determines how the virtual experience functions.

For example, the data model hierarchy 402 may be processed to take the form of a JavaScript Object Notation (JSON) tree. By representing the data model hierarchy 402 as a JSON tree, this represents the data model hierarchy 402 using text, which makes it possible to provide the JSON tree as textual input to the LLM. The JSON tree may then be transformed into a compact representation 412. The compact representation 412 may be derived from a sub-tree 404. The sub-tree 404 may include nodes associated with a selected portion of the hierarchy 406, nodes added/modified within a threshold time 408, and/or nodes associated with a global container 410.

For example, the data model hierarchy 402 may be have the form of a JSON tree that may have a root node, and branch into child nodes, where each child node may have its own child nodes. One or more of the nodes may be designated as global containers. For example, nodes associated with a selected portion of the hierarchy 406 may include particular, selected nodes in the hierarchy along the data model tree path. Nodes added/modified within a threshold time 408 may include recently added/modified nodes. Such nodes may include instances instantiated or updated nodes in the recent K conversation rounds. There may also be nodes associated with a global container 410. For example, the global containers may be a global container of content to display at launch of a game, a global container of scripts to be run only on the server, a global container corresponding to a service that sets default properties of a player object when a player enters a server, etc.

The compact representation 412 may be sent from the client device to a server device when sending the request to the LLM. Because the compact representation 412 is potentially smaller than the original JSON tree of the data model hierarchy 402, while still capturing relevant data from the data model hierarchy 402 to be used for script generation, this facilitates sending information about the data model from the client to the server. The LLM has the data model hierarchy in the context information, and therefore, the generated script refers to entities within the data model hierarchy.

Once the server device receives the compact representation 412, the compact representation 412 may be converted into one or more additional prompts for the LLM by performing one or more of deserialization of the compact representation, transformation of the compact representation, formatting of the compact representation, or any combination thereof.

The transformation process may also occur recursively. For example, to obtain better quality output from the LLM, the system prompt instructs the LLM to first act as a planner, the planner taking into account the user prompt (requesting a script) and other information, and generating a plan to create the script. For example, a sample plan may be “1. First interpret the data model hierarchy and identify all available entities. 2. Map any entity identifier (e.g., “this tree” “me”) to specific entities (e.g., “the tree selected by the user” “the user's avatar”). If there are no entity identifiers, map to global container. 3. Interpret the natural language prompt based on #2 above and generate the script.”

Once the LLM has completed acting as a planner, the LLM executes the three steps above sequentially to generate and attach the script. There may also be an option to provide the LLM-generated plan to the user and obtain user feedback/modifications (before executing the plan by 3 LLM calls for the 3 steps).

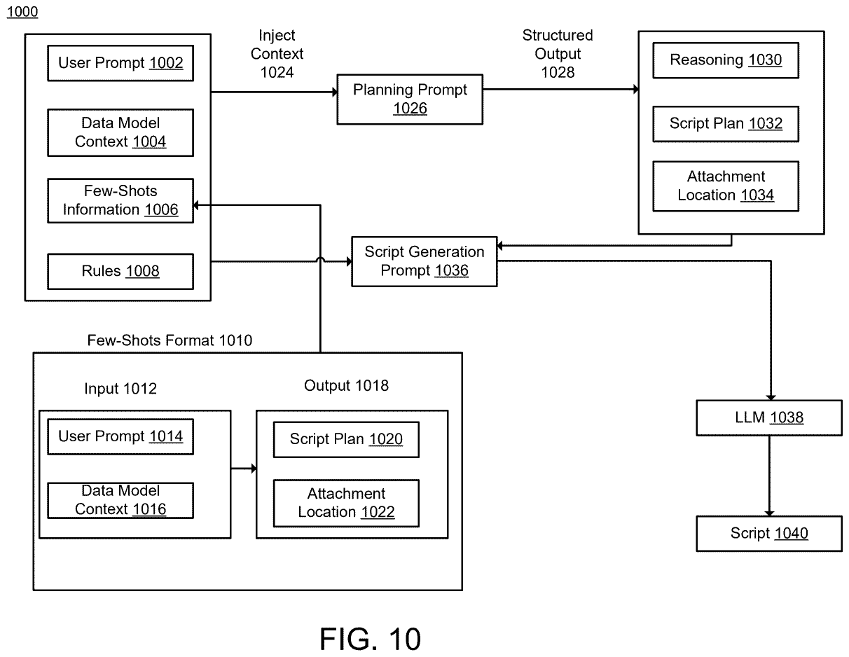

FIG. 5 is a flowchart of an example method 500 to use an LLM as a planner for script generation, in accordance with some implementations. Method 500 may begin at block 502. Additional aspects of constructing and using such a plan are described with reference to FIG. 10.

At block 502, the LLM is instructed to act as a planner. For example, the LLM may be instructed to act as a planner based on the natural language prompt and a selection context corresponding to the prompt. Block 502 may be followed by block 504.

At block 504, the LLM generates a plan. The generated plan provides sequential operations used to successfully create the script, when creating the script using the LLM. Block 504 may be followed by block 506.

At block 506, the plan is provided to a user. For example, the plan may be provided to the user at a user interface (UI) of a client device. The plan, as provided to the user, permits a user to finalize the plan before using the plan to actually generate the script in method 600. Such providing may after the LLM has generated the plan.

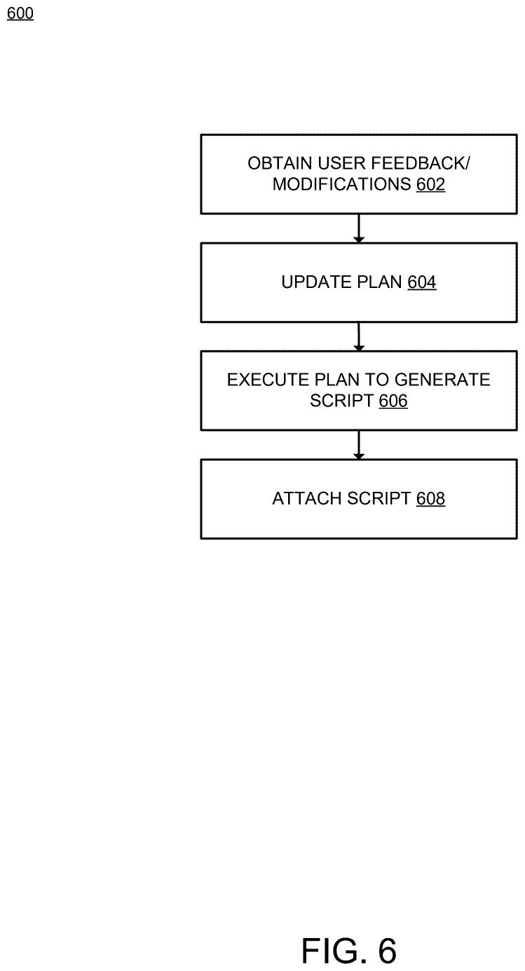

FIG. 6 is a flowchart of an example method 600 to use an LLM as a planner for script generation, in accordance with some implementations. Method 600 may begin at block 602.

At block 602, user feedback and/or modifications to the plan are obtained. For example, a user may use the same UI used at block 506 to enter edits and/or changes to the plan provided at block 506. Block 602 may be followed by block 604.

At block 604, the plan is updated. The user feedback and/or modifications change the contents of the script. Such updating may occur before executing the sequential operations in the plan. Block 604 may be followed by block 606.

At block 606, the plan is executed to generate the script. While FIG. 5 and FIG. 6, as presented, include block 506, block 602, and block 604, which include presenting a plan to a user prior to executing that plan to permit the user to refine the plan (which improves the potential success of the plan, when executed), all or a subset of these blocks may be optional. For example, block 602 and block 604 may be omitted. In this case, the user is provided with the script, but no user input is received before the script is executed. In various implementations, all of block 506, block 602, and block 604 are omitted and the plan is simply executed without user involvement. Block 606 may be followed by block 608.

At block 608, the script is attached. For example, part of the generation process of the script may include performing operations to determine where to attach the script. Alternatively, the user may provide input, such as a selection of an object, that guides where to attached the script once it is generated. Subsequently, the attached script can be executed.

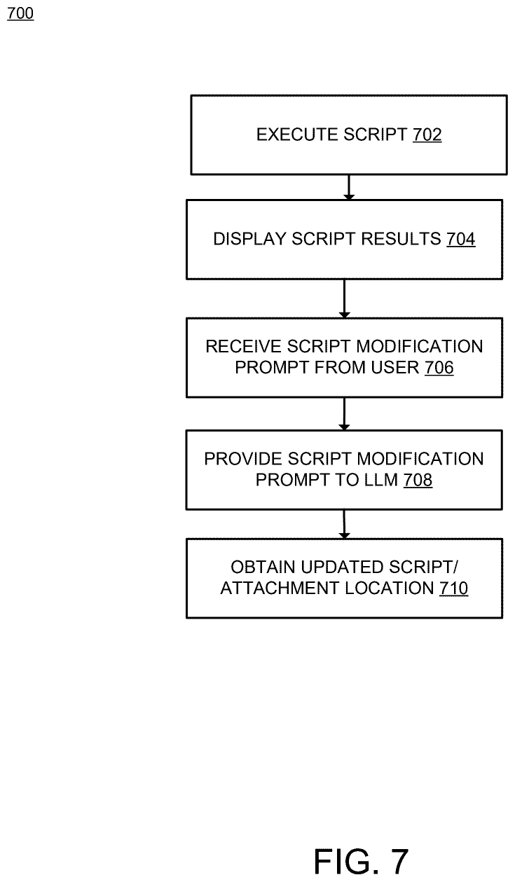

FIG. 7 is a flowchart of an example method 700 to interactively update a script, in accordance with some implementations. Method 700 begins with a script that may be generated using a properly prepared LLM or based on using a plan (as discussed in FIGS. 5-6). Method 700 may begin at block 702.

At block 702, the script is executed. Such an execution corresponds to an initial execution of the script, which may act as a baseline for further execution and refinement of the script. Block 702 may be followed by block 704.

At block 704, the script results are displayed. The script results are displayed to a user who may be able to iteratively improve the script. Block 704 may be followed by block 706.

At block 706, a script modification prompt is received from a user. Such a prompt may be input from the user with instructions about how to modify the script based on results obtained at block 702 and block 704 with the aim of achieving user-set objectives. Block 706 may be followed by block 708.

At block 708, the script modification prompt is provided to the LLM. Such a script modification prompt expresses the user's preferences about how to modify the script. For example, the script modification prompt may include a new prompt which is used to generate a new script. As an alternative, the script modification prompt may be a natural language instruction that provides the LLM with additional instructions about how to generate the script. For example, the additional instructions may be an instruction about intended changes to the original prompt to impose prior to generating the script, or an instruction about how to modify the script based on identified problems with the script. Block 708 may be followed by block 710.

At block 710, an updated script/attachment location is obtained. For example, the script modification instruction may cause the LLM to generate an updated script. Along with the updated script, the LLM may also generate a new/updated attachment location for the updated script. The LLM, as discussed herein, may be designed to identify an attachment location for the generated script as part of the process of generating the script. While not illustrated in FIG. 7, once the updated script/attachment location are obtained, the script can be attached and then executed, as discussed elsewhere herein.

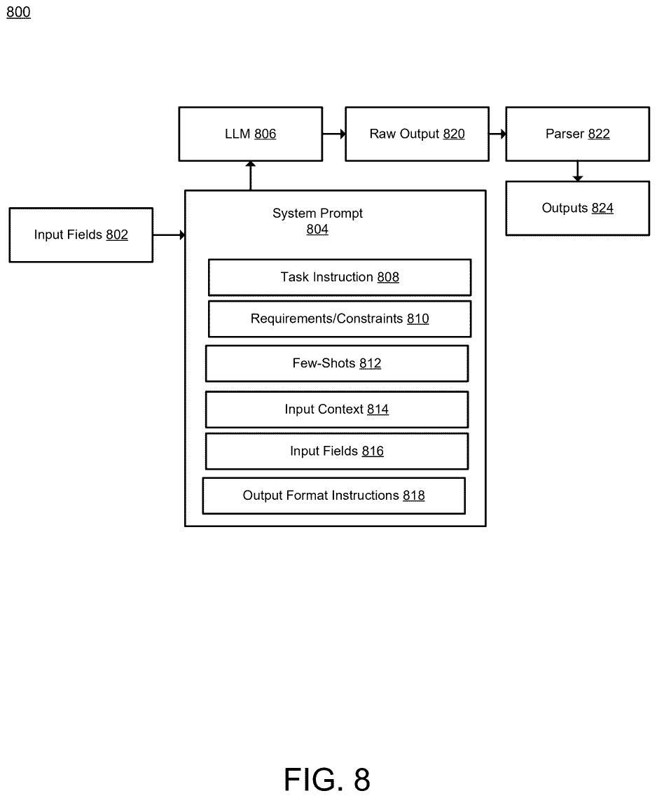

FIG. 8 is a diagram 800 illustrating an example of prompt engineering flow, in accordance with some implementations. The flow of FIG. 8 may begin with input fields 802. Input fields for a large language model (LLM) include the user's text prompt and other structured data, such as tokens, multi-modal data (like images), and configurable parameters that guide the LLM's behavior. These inputs are useful for controlling the LLM's output, ranging from freeform text to structured data like JSON, and can also include settings for things like output creativity and penalties.

The input fields 802 are provided in conjunction with a system prompt 804. A system prompt 804 is a pre-structured format for providing instructions and context to an LLM to guide its behavior, tone, and output. The LLM sets the rules and boundaries for the AI, separate from user-provided input, and acts as a guiding framework for its responses throughout an interaction.

Templates make prompts consistent by using placeholders for dynamic information. The system prompt 804 is provided to an LLM 806. The system prompt 804 is also provided to specify various parameters and aspects of the generation. These parameters include task instruction 808, requirements/constraints 810, few-shots 812, input context 814, input fields 816, and/or output format instructions 818.

The task instruction 808 is a natural language command that specifies a task for the LLM to perform, often including context, constraints, and intended output format. These instructions are used in a process called “instruction tuning,” which fine-tunes a base LLM to become better at following commands and performing diverse tasks like summarization, coding, or question-answering. Clear instructions are essential for getting the intended output from the LLM.

The requirements/constraints 810 may be categorized into two main types: technical constraints related to the LLM's computational and hardware specifications, and functional constraints that dictate the output, such as formatting, content, and behavior. Technical constraints include the computational power, memory, and storage used to run the LLM, with larger LLM's consuming more resources. Functional constraints, often set through prompting or fine-tuning, define specific rules for the output, like using a specific format, adhering to a character limit, or avoiding certain topics.

The few-shots 812 may include information for few-shot prompting. Few-shot prompting is a technique where a user provides a large language model (LLM) with a few examples of the task a user intends the LLM to perform within the prompt itself. This helps the LLM model the intended output format, style, and task, making the output more accurate and relevant than if the LLM were given only an instruction. Using few-shots 812 is a quick way to guide an LLM without the reliance on more extensive fine-tuning.

The input context 814 with respect to an LLM prompt refers to the surrounding information, such as the initial instructions, conversational history, and provided examples, that the LLM uses to represent a user's request and generate a relevant response. This context is limited by the LLM's context window, which is a specific number of tokens (pieces of words or characters) that the LLM can process at any given time.

The input fields 816 refer to specific, structured components used to construct a complete prompt, which the LLM processes to generate an intended response. These fields, often embedded within a larger template, provide for the dynamic insertion of data and instructions. The input fields 816 help provide structure for the LLM that aid the LLM in the script generation process.

The output format instructions 818 are prompts that tell the LLM to structure its response in a specific, predictable way, such as JSON or XML. This makes the output easier for both humans and machines to parse, which is helpful for integrating LLMs into software pipelines and applications. It may be possible to provide these instructions by explicitly stating the intended format in the prompt or by including examples of the correct structure.

Based on the input fields 802 and the other information associated with the system prompt 804 (task instruction 808, requirements/constraints 810, few-shots 812, input context 814, input fields 816, and/or output format instructions 818) the LLM 806 provides raw output 820, which is fed into a parser 822. Based on the raw output 820, the parser 822 then generates outputs 824. For example, the outputs 824 may include a generated script, as well as information about how to place/attach the generated script.

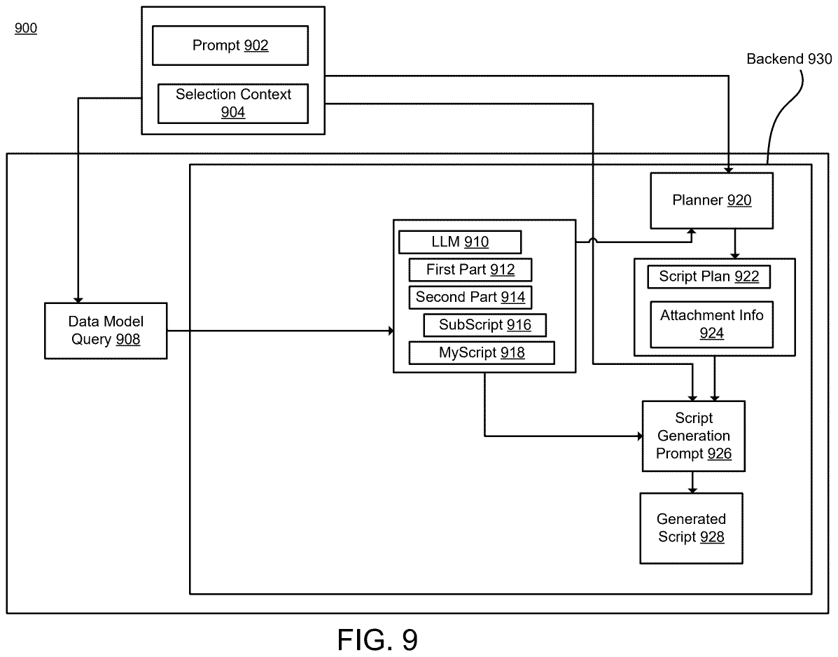

FIG. 9 is a diagram 900 illustrating an example LLM chaining flow, in accordance with some implementations. FIG. 9 illustrates that the input provided to the backend 930 is a prompt 902 and a selection context 904. The prompt 902 and selection context 904 are processed to provide a data model query 908. The data model query 908 is provided to the backend 930. The backend 930 processes the data model query 908 into information such as an LLM 910 having example parts such as a first part 912, a second part 914, a subscript 916, and a personalized script 918.

The prompt 902 and the selection context 904, as well as the LLM 910 as discussed above and other related information (as discussed herein) are provided as input to a planner 920. The planner 920 takes this input information and generates a script plan 922 and attachment information 924. For example, a planner 920 may be an LLM fine-tuned to take input of the sort discussed above and generate a corresponding script plan 922 and attachment information 924.

The prompt 902, selection context 904, the LLM 910 and the associated information (e.g., first part 912, second part 914, subscript 916, and personalized script 918), and the script plan 922 and the attachment information 924 are used as the basis of a script generation prompt 926. The script generation prompt 926 is then provided to an LLM and used to generate a final generated script 928. This generated script 928 may then be attached with the virtual environment based on the attachment information 924 and/or based on results of providing the attachment information 924 to the LLM when generating the generated script 928 to better determine how to attach and/or execute the generated script 928.

FIG. 10 is a diagram 1000 illustrating an example chaining flow, in accordance with some implementations. FIG. 10 illustrates that the LLM's input begins with a user prompt 1002, data model context 1004, few-shots information 1006, and rules 1008. The user prompt 1002 is a natural language prompt instructing the LLM what the user intends for the generated script to do. The data model context 1004 is about representing which part of the system the generated script is to run in and what permissions and access the generated script has within the larger game hierarchy. The rules 1008 are additional prompting content that guide construction of a script and related information.

The few-shots format 1010 is illustrated in expanded detail in FIG. 10 at few-shots format 1010. As discussed above, few-shot prompting is a technique in which a large language model is given a few examples of an input-output pair to help the LLM model a task and its intended output format before being asked to perform the task on a new input. This method improves accuracy and helps the LLM grasp nuances for more complex tasks where a simple instruction (zero-shot prompting) is not enough. For instance, the few-shots format 1010 can be used to convey to the LLM how to extract specific information from text and format the text as a JSON object.

For example, few-shots format 1010 may include examples of input 1012 and corresponding output 1018. The input 1012 may include a user prompt 1014 and data model context 1016. The user prompt 1014 may be a natural language prompt and the data model context 1016 may include various information, which may be provided as prompts to the LLM, that help prepare the LLM to effectively process user prompt 1014. When the example input 1012 is provided, example input 1012 yields corresponding output 1018.

The example output 1018 may include a resulting script plan 1020 and attachment location 1022. The script plan 1020 and attachment location 1022 may be incorporated into the few-shots information 1006. Thus, few-shots information 1006 includes a number of examples of input 1012 and corresponding examples of outputs 1018, illustrating how each example input 1012 including user prompts 1014 and data model context 1016 information maps to a corresponding output 1018 including script plans 1020 and attachment locations 1022.

The initial information (user prompt 1002, data model context 1004, few-shots information 1006, rules 1008) are used to inject context 1024 to generate a planning prompt 1026. Injecting context into an LLM means providing the LLM with relevant external information to improve its responses beyond its base training data. This process involves dynamically adding information like documents, conversation history, database records, or instructions to the user's query to make the LLM's output more accurate, relevant, and effective for a specific task. Injecting context is an important part of context engineering, which aims to build systems that give the LLM the right information at the right time.

The planning prompt 1026 is then used to generate structured output 1028. The structured output 1028 generated from the planning prompt 1026 may generate planning results including reasoning 1030, a script plan 1032, and information about an attachment location 1034. The initial information (the user prompt 1002, the data model context 1004, the few-shots information 1006, and the rules 1008) may then be used in combination with the results of the planner in response to the planning prompt 1026 (the reasoning 1030, the script plan 1032, and the attachment location 1034) to provide a finalized script generation prompt 1036.

This script generation prompt 1036 then yields, when provided to an LLM 1038, a final script 1040. The LLM 1038 used to take the script generation prompt 1036 may use parts of the script generation prompt 1036 to identify a user's preferences for the script, and other part of the script generation prompt 1036 to instruct the LLM 1038 how to effectively generate a script that satisfies those preferences. The final script 1040 may be placed, such as based on attachment location 1034 and/or otherwise attached and executed.

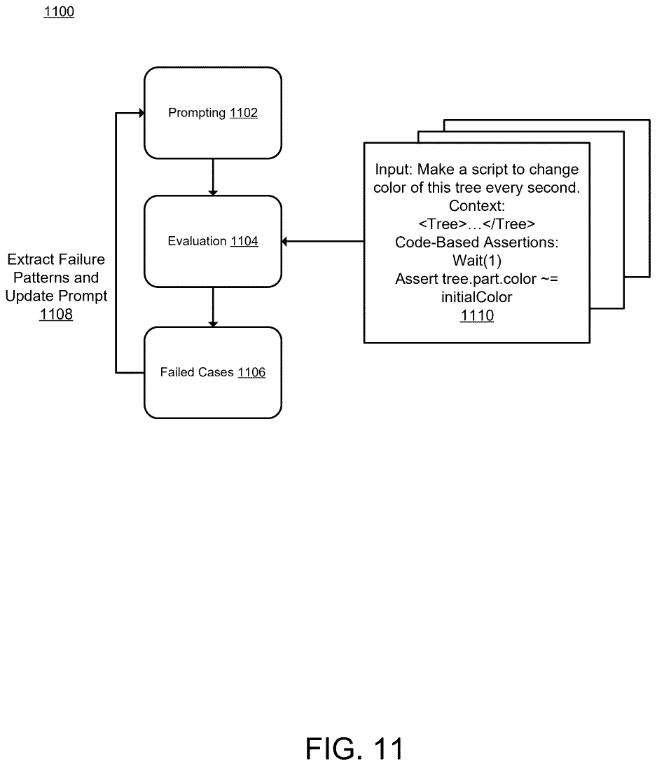

FIG. 11 is a diagram 1100 illustrating iterative prompt updation, in accordance with some implementations. In FIG. 11, the prompt updating cycle includes prompting 1102, which is followed by evaluation 1104 based on an input 1110 in response to the prompting 1102, which may generate failed cases 1106. From the failed cases 1106, the user and/or the LLM are able to extract failure patterns and update the prompt 1108.

For example, the input 1110 may be a prompt to “Make a script to change color of this tree every second” along with a context specifying “<Tree> . . . </Tree> which may be a tag to the code affecting prompts of the tree referred to in the prompt, along with a Code-Based Assertion of “Wait(1)” (so that changes occur every second) and “Assert tree.part.color ˜=initialColor” (so that the color changes from what the color was previously). Suppose that evaluation 1104 generates a script that presents issues with achieving the user's preferences. If there are problems with evaluation of the input 1110, there can be an iterative correction process.

Thus, the prompting 1102 leads to receiving input 1110 that is subject to evaluation 1104, which identifies the failed cases 1106. The failed cases 1106 may be identified automatically, identified by using user input/feedback, or by a combination of these. The failed cases 1106 may be used (automatically, manually, or a combination of these) to extract failure patterns and update the prompt 1108 (again, manually, or a combination of these).

Thus, FIG. 11 illustrates an iterative structure for script refinement. At each iteration, issues are identified based on results of a round of executed and actions to ameliorate the issues are taken by changing the prompt. The iteration may continue until a termination condition is met. For example, if no further issues are identified, if a user indicates that the script is acceptable, if a termination condition is met, if a quality score associated with the script attains a threshold, etc.

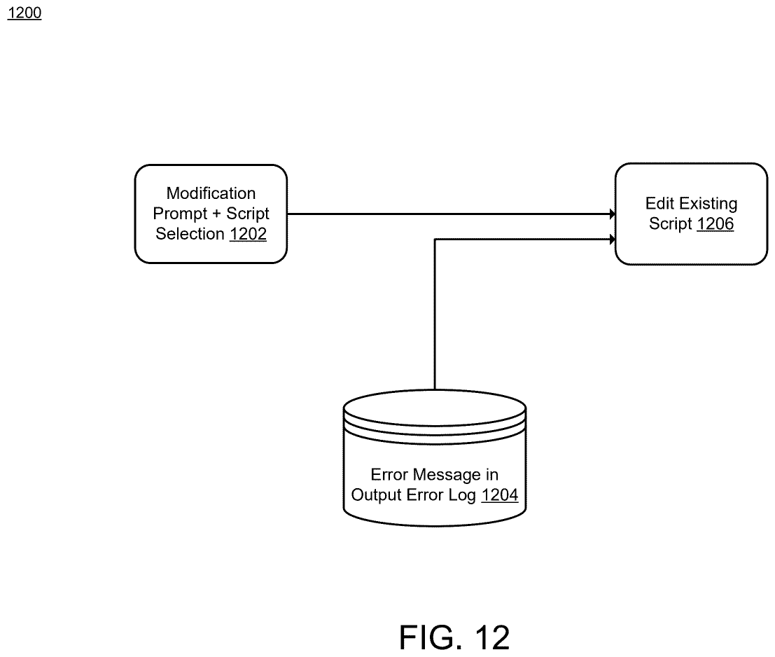

FIG. 12 is a diagram 1200 illustrating prompt-driven script editing, in accordance with some implementations. FIG. 12 illustrates a simple approach to script editing and refinement. FIG. 12 begins with a modification prompt and a script selection 1202. The modification prompt includes an instruction (which is provided by a user who wishes to make changes to a given script) and the script selection is information about which script is to be modified These are combined with an error message 1204 in an output error log.

The error message 1204 may provide information about which kinds of modifications are necessary, in combination with the modification prompt and script selection. These pieces of information (modification prompt and script selection 1202 and the error message) are then combined to edit an existing script 1206. While this simple approach may offer a partial ability to improve scripts, other implementations may improve on this simple approach. More specially, other implementations may use AI, such as by using an LLM with prompts in a specific manner to generate scripts and related information with better results.

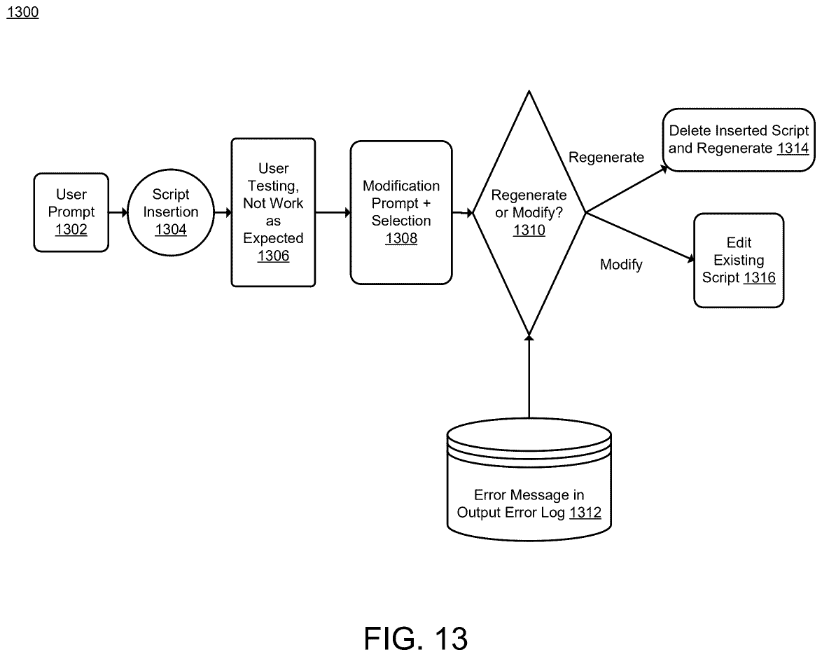

FIG. 13 is a diagram 1300 illustrating script editing using artificial intelligence (AI), in accordance with some implementations. For example, FIG. 13 begins with a user prompt at block 1302. As discussed above, the user prompt at block 1302 may include a natural language prompt expressing a user's preferences for a script to be generated as well as other information to help an LLM successfully generate such a script.

The user prompt at block 1302 is used as the basis of script insertion at block 1304. For example, the script insertion at block 1304 may take as input a script generated in response to the user prompt at block 1302. When generating the script, a script insertion location and other information to aid in the insertion of the script may be generated at the same time. Alternatively, such information may be received and/or selected using separate processes.

The script insertion at block 1304 may be followed by user testing of the inserted script, which may reveal that the inserted script does not work as expected at block 1306. This user testing at block 1306 is followed by modification of the prompt and selection of alternatives (to the prompt) at block 1308. Block 1308 may be followed by block 1310, at which it is determined whether to regenerate or modify the previous prompt. This determination may be based on user input.

Block 1310 may also incorporate into the process of providing another script error message(s) in an output at block 1312. If the selection made (e.g., received from a user) at block 1310 is to regenerate, the previously inserted script is deleted from where the previously inserted script was inserted at block 1304. If the selection made at block 1310 is to modify, the previously inserted script is modified and replaces what was inserted at block 1304.

For example, at block 1310, the user picks a preferred approach from regenerate or modify. If the user picks to regenerate the prompt, the inserted script is deleted and regenerated at block 1314. If the user picks to modify the script, the inserted script is edited at block 1316.

Whether the next script is produced at block 1314 or block 1316, if issues remain with the generated script, the operations performed in FIG. 13 may be repeated until any issues with the script are fully resolved or another termination condition occurs.

FIG. 14 is a block diagram that illustrates an example computing device which may be used to implement one or more features described herein, in accordance with some implementations. In one example, computing device 1400 may be used to implement a computer device (e.g., server 102 and/or client device 110 of FIG. 1), and perform appropriate method implementations described herein. Computing device 1400 can be any suitable computer system, server, or other electronic or hardware device. For example, the computing device 1400 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1400 includes a processor 1402, a memory 1404, input/output (I/O) interfaces 1406, and audio/video input/output devices 1414.

Processor 1402 can be one or more processors and/or processing circuits to execute program code and control basic operations of the computing device 1400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1404 is typically provided in computing device 1400 for access by the processor 1402, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 1402 and/or integrated therewith. Memory 1404 can store software operating on the computing device 1400 by the processor 1402, including an operating system 1408, a virtual experience application 1410, a script insertion application 1412, and other applications (not shown). In some implementations, virtual experience application 1410 and/or script insertion application 1412 can include instructions that enable processor 1402 to perform the functions (or control performance of the functions of) described herein (e.g., some or all of the methods described with respect to FIGS. 2 and 5-7).

For example, virtual experience application 1410 (which can be embodied by the virtual experience applications 112 or 132 in FIG. 1) can include a script insertion application 1412, which as described herein can manage the generation and insertion of scripts within an online virtual experience server (e.g., server 102). Elements of software in memory 1404 can alternatively be stored on any other suitable storage location or computer-readable medium. In addition, memory 1404 (and/or other connected storage device(s)) can store instructions and data used in the features described herein. Memory 1404 and any other type of storage (magnetic disk, optical disk, magnetic tape, or other tangible media) can be considered “storage” or “storage devices.”

I/O interface(s) 1406 (which can be embodied by the I/O interface 114 of FIG. 1) can provide functions to enable interfacing the computing device 1400 with other systems and devices. For example, network communication devices, storage devices (e.g., memory and/or data store 120), and input/output devices can communicate via I/O interface(s) 1406. In some implementations, the I/O interface(s) 1406 can connect to interface devices including input devices (e.g., keyboard, pointing device, touchscreen, microphone, camera, scanner, etc.) and/or output devices (e.g., display device, speaker devices, printer, motor, etc.).

The audio/video input/output devices 1414 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 14 shows one block for each of processor 1402, memory 1404, I/O interface(s) 1406, and software blocks of operating system 1408, virtual experience application 1410, and script insertion application 1412. These blocks may represent one or more processors or processing circuitries, operating systems, memories, I/O interfaces, applications, and/or software engines. In other implementations, computing device 1400 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform or control performance of the operations described.

A user device can also implement and/or be used with features described herein. Example user devices can be computer devices including some similar components as the computing device 1400 (e.g., processor(s) 1402, memory 1404, and I/O interface(s) 1406). An operating system, software and applications suitable for the client device can be provided in memory and used by the processor. The I/O interface for a client device can be connected to network communication devices, as well as to input and output devices (e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices). A display device within the audio/video input/output devices 1414, for example, can be connected to (or included in) the computing device 1400 to display images pre- and post-processing as described herein, where such display device can include any suitable display device (e.g., an LCD, LED, or plasma display screen, CRT, television, monitor, touchscreen, 3-D display screen, projector, or other visual display device). Some implementations can provide an audio output device (e.g., voice output or synthesis that speaks text).

One or more methods described herein (e.g., methods 200, 500, 600, and 700) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to automatically insert a script in a virtual environment, the method comprising:
receiving a natural language prompt from a user, the natural language prompt specifying one or more functional requirements for the script;
providing the natural language prompt, a default prompt, and context information to a large language model (LLM);
obtaining, as output of the LLM and in response to the providing, the script and an attachment location for the script, wherein the attachment location identifies a particular entity associated with the virtual environment; and
inserting the script in the virtual environment at the attachment location, wherein the script is executable in the virtual environment after the inserting.

2. The computer-implemented method of claim 1, wherein the default prompt includes a task instruction, at least one example prompt and a corresponding example script, one or more script insertion rules, or any combination thereof.

3. The computer-implemented method of claim 1, further comprising receiving a selection of a virtual object within the virtual environment from the user, and wherein providing the context information to the LLM comprises providing an identification of the virtual object.

4. The computer-implemented method of claim 3, wherein the particular entity is the virtual object.

5. The computer-implemented method of claim 1, wherein the context information is from the virtual environment and includes a data model hierarchy for the virtual environment that includes information about entities associated with the virtual environment including the particular entity.

6. The computer-implemented method of claim 5, wherein the data model hierarchy for the virtual environment is represented as a JavaScript Object Notation (JSON) tree and the method further comprises, prior to providing the data model hierarchy to the LLM, transforming the data model hierarchy into a compact representation that includes a sub-tree comprising nodes associated with a selected portion of the data model hierarchy, nodes added or modified within a threshold time, and nodes associated with a global container, wherein the global container is a data structure that includes data regarding the entities associated with the virtual environment.

7. The computer-implemented method of claim 1, wherein the context information includes one or more previous prompts from the user, one or more previous outputs of the LLM, or a combination thereof.

8. The computer-implemented method of claim 7, wherein the particular entity includes a global container associated with the virtual environment, wherein the global container is a data structure that includes data regarding entities associated with the virtual environment.

9. The computer-implemented method of claim 1, further comprising instructing the LLM to act as a planner based on the natural language prompt and a selection context, wherein the LLM generates a plan comprising sequential operations to create the script, executes the sequential operations in the plan to create the script, and attaches the script.

10. The computer-implemented method of claim 9, further comprising:
after the LLM generates the plan, providing the plan to the user;
obtaining user feedback, user modifications, or a combination thereof with respect to the plan; and
before executing the sequential operations in the plan, updating the plan based on the user feedback, the user modifications, or the combination thereof.

11. The computer-implemented method of claim 1, further comprising:
executing the script;
after executing the script, displaying to the user results of the execution of the script;
receiving one or more script modification prompts from the user;
providing the script modification prompts to the LLM; and
obtaining, from the LLM, an updated script, an updated attachment location, or a combination thereof.

12. The computer-implemented method of claim 1, wherein the obtaining comprises obtaining the script prior to obtaining the attachment location or obtaining the attachment location prior to obtaining the script.

13. A non-transitory computer-readable medium with instructions stored thereon that, responsive to execution by a processing device, causes the processing device to perform or control performance of operations comprising:
receiving a natural language prompt from a user, the natural language prompt specifying one or more functional requirements for a script;
providing the natural language prompt, a default prompt, and context information to a large language model (LLM);
obtaining, as output of the LLM and in response to the providing, the script and an attachment location for the script, wherein the attachment location identifies a particular entity associated with a virtual environment; and
inserting the script in the virtual environment at the attachment location, wherein the script is executable in the virtual environment after the inserting.

14. The non-transitory computer-readable medium of claim 13, wherein the context information is from the virtual environment and includes a data model hierarchy for the virtual environment that includes information about entities associated with the virtual environment including the particular entity.

15. The non-transitory computer-readable medium of claim 13, wherein the context information includes one or more previous prompts from the user, one or more previous outputs of the LLM, or a combination thereof.

16. The non-transitory computer-readable medium of claim 13, wherein the operations further comprise instructing the LLM to act as a planner based on the natural language prompt and a selection context, wherein the LLM generates a plan comprising sequential operations to create the script, executes the sequential operations in the plan to create the script, and attaches the script.

17. A system comprising:
a memory with instructions stored thereon; and
a processing device, coupled to the memory, the processing device configured to access the memory and execute the instructions, wherein the instructions cause the processing device to perform or control performance of operations comprising:
receiving a natural language prompt from a user, the natural language prompt specifying one or more functional requirements for a script;
providing the natural language prompt, a default prompt, and context information to a large language model (LLM);
obtaining, as output of the LLM and in response to the providing, the script and an attachment location for the script, wherein the attachment location identifies a particular entity associated with a virtual environment; and
inserting the script in the virtual environment at the attachment location, wherein the script is executable in the virtual environment after the inserting.

18. The system of claim 17, wherein the context information is from the virtual environment and includes a data model hierarchy for the virtual environment that includes information about entities associated with the virtual environment including the particular entity.

19. The system of claim 17, wherein the context information includes one or more previous prompts from the user, one or more previous outputs of the LLM, or a combination thereof.

20. The system of claim 17, wherein the operations further comprise instructing the LLM to act as a planner based on the natural language prompt and a selection context, wherein the LLM generates a plan comprising sequential operations to create the script, executes the sequential operations in the plan to create the script, and attaches the script.
